(19) United States
(12) Patent Application Publication
(10) Pub. No.: US 2009/0001941 A1
(43) Pub. Date: Jan. 1, 2009

(54) Inductive Powering Surface for Powering Portable Devices

(75) Inventors: Feng-Hsiung Hsu, Cupertino, CA (US); Zenglin Xia, Beijing (CN)

Correspondence Address: LEE & HAYES PLLC, 601 W Riverside Avenue, Suite 1400, SPOKANE, WA, 99201, US

(73) Assignee: Microsoft Corporation, Redmond, WA (US)

(21) Appl. No.: 11/771,952

(22) Filed: Jun. 29, 2007

(51) Int. Cl. G05F 1/70

(52) U.S. Cl. 323/211

(57) ABSTRACT

Systems and methods for an inductive powering surface for powering portable devices are described. In one aspect, a powering device includes the inductive powering surface. The inductive powering surface includes multiple primary coils, an impedance auto-match circuit and other control circuits. The impedance auto-match circuit selectively energizes the primary coils to transfer power via inductive coupling to the secondary coil(s) in a portable device. The impedance auto-match circuit is configured to detect voltage and current phase differences over caused by positioning of the portable device on the inductive powering surface. The impedance auto-match circuit calibrates a power factor of the inductive powering surface to transfer an objectively maximized power load via inductive coupling to the portable device.

### BACKGROUND

An inductive powering surface provides power to a portable device via inductive coupling between primary coils in the surface and secondary coils in the portable device. The portable device includes a passive locator device, such as RFID (Radio Frequency Identification), that allows the primary coils of the inductive powering surface to detect the presence and location of the device. Only primary coils adjacent to the secondary coils are energized for power transfer.

### SUMMARY

Systems and methods for an inductive powering surface for powering portable devices are described. In one aspect, a powering device includes the inductive powering surface. The inductive powering surface includes multiple primary coils, an impedance auto-match circuit and other control circuits. The impedance auto-match circuit selectively energizes the primary coils to transfer power via inductive coupling to the secondary coil(s) in a portable device. The impedance auto-match circuit is configured to detect voltage and current phase differences over caused by positioning of the portable device on the inductive powering surface. The impedance auto-match circuit calibrates a power factor of the inductive powering surface to transfer an objectively maximized power load via inductive coupling to the portable device.

This Summary is provided to introduce a selection of concepts in a simplified form that are further described below in the detailed description. This Summary is not intended to identify key features or essential features of the claimed subject matter, nor is it intended to be used as an aid in determining the scope of the claimed subject matter.

### BRIEF DESCRIPTION OF THE DRAWINGS

In the Figures, the left-most digit of a component reference number identifies the particular Figure in which the component first appears.

FIG. 1 shows an exemplary system for an inductive powering surface for powering portable devices, according to one embodiment.

FIG. 2 is a schematic side view of a portable device with a secondary coil placed on a powering surface that has a plurality of primary coils for transferring power to the portable device via inductive coupling with secondary coils of the portable device, according to one embodiment.

FIG. 3 is a diagram showing an exemplary primary surface of an inductive powering surface, wherein the primary side includes power and sensor providing portions, according to one embodiment.

FIG. 4 shows an exemplary structure for an impedance auto-match circuit to calibrate power factors of inductive loads between primary coils in an inductive power surface and secondary coils in a portable device, according to one embodiment.

FIG. 5 shows an exemplary radio leakage shielding for an inductive powering surface, according to one embodiment.

FIG. 6 shows an exemplary procedure for an inductive powering surface for powering portable devices, according to one embodiment.

### DETAILED DESCRIPTION

### Overview

When a portable device is placed on various portions of a conventional inductive powering surface over time, the inductance of primary power coil(s) may change due to the impacts of magnetic materials (e.g. ferrite) associated with the portable device. If the voltage and current is not in phase and the power factor is low, then maximized amounts of power cannot be transferred from the powering surface to the portable device. However, it is difficult to calibrate a power factor using fixed-value capacitors of conventional inductive powering surfaces. Systems and methods for an inductive powering surface for powering portable devices, which are described below in reference to FIGS. 1 through 6, address such a power factor mismatch scenario common to conventional inductive powering and powered systems.

Specifically, the systems and methods for an inductive powering surface for powering portable devices provide power transfer using a novel impedance auto-match technique to calibrate and periodically calibrate the power factor. The primary coils are energized to transfer a power load via inductive coupling with secondary coils in the portable device when the portable device is placed on the inductive powering surface. Responsive to such coupling, the inductive powering surface's impedance auto-match logic automatically compensates for variation of coil inductance between the primary and secondary coils by changing capacitor values associated with the powering surface. This compensation allows the systems and methods to provide optimized power transfer between the powering surface and the portable device. In one implementation, the inductive powering surface includes a thin metal sheet mounted outside of secondary ferrite and primary ferrite to shield radio leakage.

These and other aspects of the systems and methods for an inductive powering surface for powering portable devices are now described in greater detail.

### An Exemplary System

Although not required, the systems and methods for inductive powering surface for powering portable devices are described in the general context of computer-program instructions being executed by one or more controllers such as a Microcontroller Unit (MCU), a Complex Programmable Logic Device (CPLD), etc. An MCU, for example, is a single chip that contains a processor, RAM, ROM, clock and I/O control unit. Program modules generally include routines, programs, objects, components, data structures, etc., that perform particular tasks or implement particular abstract data types.

FIG. 1 shows an exemplary system 100 for an inductive powering surface for powering portable devices are described, according to one embodiment. In this implementation, system 100 includes a portable device with secondary coil(s) placed on a powering surface that has a plurality of primary coils for transferring power to the portable device via inductive coupling with the secondary coil. More particularly, system 100 includes a powering device 102 with an inductive powering surface 104 for transferring power to a portable device 106 placed on the surface 104. The powering device 102 may be in the form of, for example, a computer desk, a conference table, a night stand, or a powering pad, etc. There are no particular limitations on the shape and form of the powering device. Inductive powering surface 104 transfers power to portable device 106 independent of direct physical electrical contacts or connections. For example, if the powering device 102 is a conference table, users participating in a meeting only have to place their laptop computers or tablet PCs on the surface of the table, and their portable device(s) 106 will be automatically powered or recharged by the table surface (i.e., the powering surface 104).

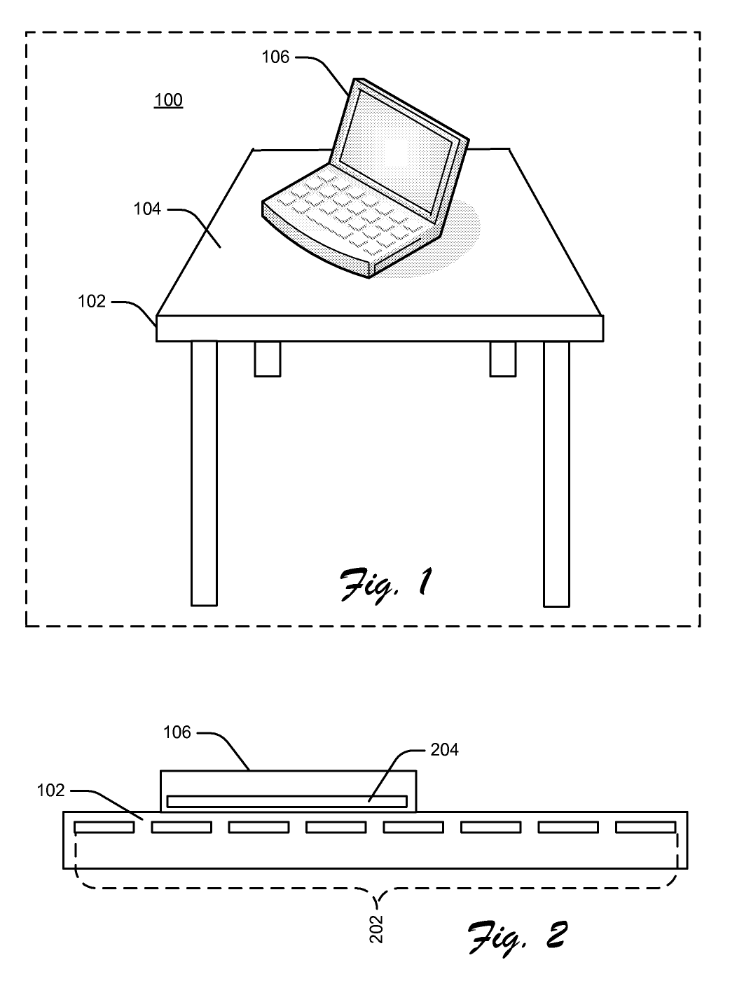

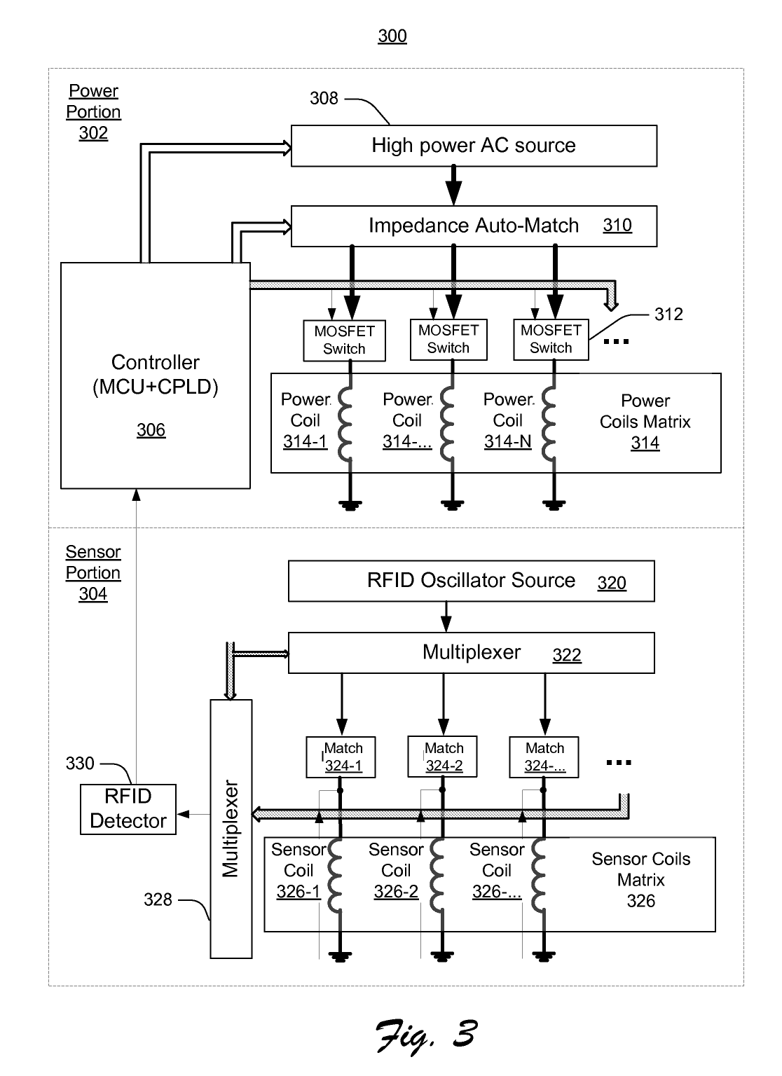

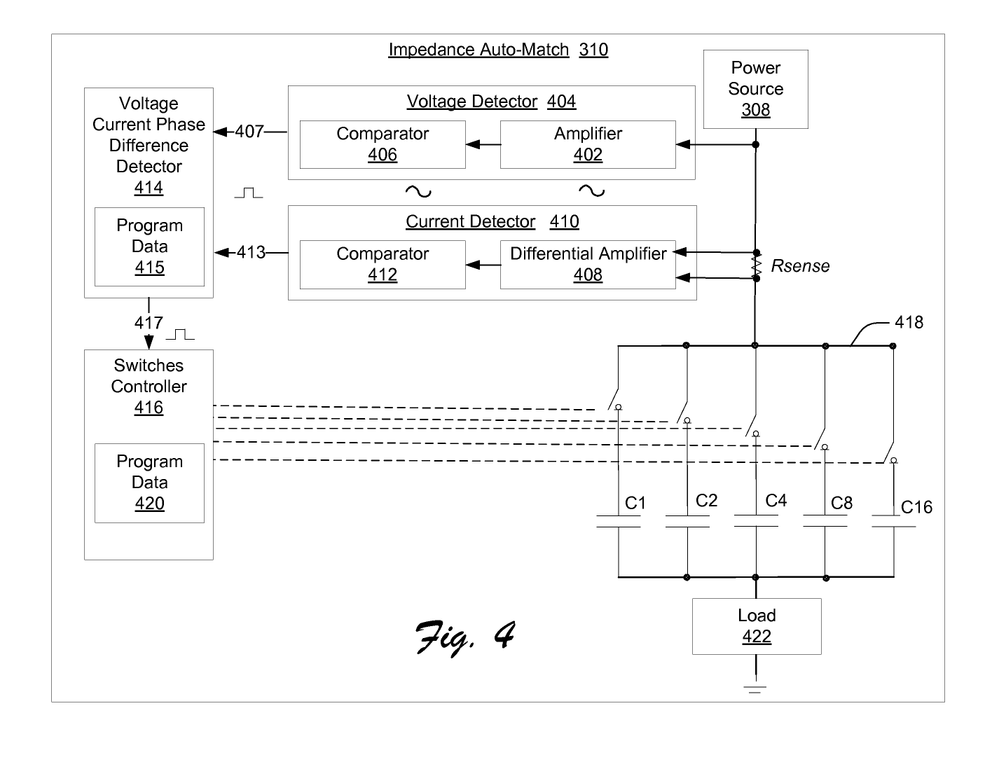

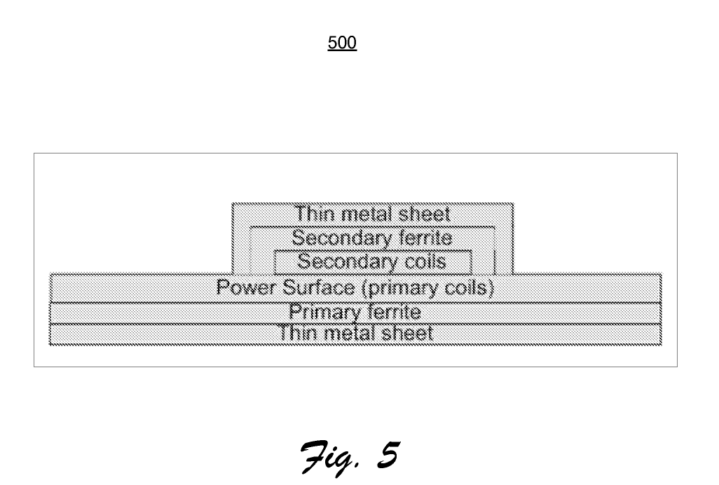

FIG. 2 is a schematic side view of a portable device with a secondary coil placed on a powering surface that has a plurality of primary coils for transferring power to the portable device via inductive coupling with secondary coils of the portable device, according to one embodiment. The power transfer from the inductive powering surface 104 to the portable device 106 is by means of the inductive coupling between a matrix of primary (power) coil(s) 202 in the inductive powering surface and secondary coil(s) 204 in the portable device. The primary coil(s) and secondary coil(s) form a transformer. When a primary coil is driven with an alternating signal at a selected frequency, the variation of the magnetic flux is picked up by a secondary coil and induces an alternating voltage signal across the secondary coil. The alternating voltage signal is converted into power by a power supply circuit in the portable device for powering the operations of the portable device. When a portable device is placed on a different portion/area of the powering surface and inductance of one or more primary power coils associated with the powering surface may change due to the impacts of magnetic materials (e.g., ferrite, etc.) on the secondary coils (the portable device side). Conventional systems, which typically use fixed-value capacitors, do not address this scenario to calibrate the power factor between the primary and secondary coils. Here, however, a primary side of powering surface 104 includes a self-adapting impedance auto match circuit to automatically correct the power factor and maximize power transmission responsive to power load changes. We now describe such a primary side and impedance auto match circuit with respect to FIGS. 3 and 4.

FIG. 3 is a diagram showing an exemplary primary surface 300 of an inductive powering surface, wherein the primary side includes power and sensor providing portions, according to one embodiment. For purposes of exemplary description, aspects of FIG. 3 are described with respect to FIGS. 1 and 2, wherein like reference numerals refer to like elements. In this example, power providing portion 302 of inductive powering surface 104 transmits power, and sensor portion 304 detects presence and location of portable device(s) 106. In this implementation, for example, power portion 302 comprises controller 306 (e.g., a MCU, CPLD, etc.) coupled to a high power alternating current (AC) source 308. AC source 308 is coupled to impedance auto-match logic 310. Impedance auto match logic 310 regulates power transmission to portable device 106. (Greater detail of impedance auto match logic 310 is described below with respect to FIG. 4).

To regulate power transmission from primary side 300 to portable device 106, impedance auto match logic 310 and controller 306 are coupled to an array of metal-oxide-semiconductor field-effect transistors (“MOSFET switches”) 312; each MOSFET switch 312 is coupled to a respective power coil (primary coil) 314 (please also see FIG. 2) in a power coil matrix 314. Each switch 312 is used to activate its corresponding coupled primary power coil 314. For example, responsive to detecting a device 106 on power surface 104, controller 306 activates corresponding primary power coils 314. Activated power coil(s) 314 start transmitting power via inductive coupling to secondary coils 204 (please also see FIG. 2) of the detected device 106. Power coils matrix 314 comprises an arbitrary number of power (primary) coils 314-1 through 314-N, where the numbers based on the particular implementation of powering surface 104. (Primary coils 314 represent primary coils 202 of FIG. 2). Voltage and current are not in step for a reactive (inductive or capacitive) load.

Power coils 314 are selectively energized for transferring power to a portable device 106 placed on inductive powering surface 104. To maximize the efficiency of power transfer and to reduce Radio Frequency (RF) interference or unwanted exposure of transmitted power, only those power coils 314 covered by or overlapping with one or more secondary coil(s) 204 in the portable device are energized for power transfer. Thus, sensor portion 304 detects presence and location of respective secondary coil(s) 204 in association with inductive powering surface 104. To these ends, sensor portion 304 comprises, for example, RFID oscillator source 320 coupled to multiplexer 322. Oscillator source 320 outputs an AC signal at some frequency, for example, a 2 MHz frequency. Compared to high power source 308, RFID oscillator source 320 outputs a relatively low power signal. So, there is no large radio leakage while detecting portable device(s) 106. Multiplexer 322 comprises an array of switches that are turned on or off by controller 306 to activate sensor coil(s) 326 via a respective match circuit 324. Each match circuit 324 matches impedance between a respective sensor coil 326 and RFID oscillator source 320, so that the RFID source signal can be transmitted effectively. Sensor coil matrix 326 comprises, for example, an arbitrary number of sensor coils 326-1 through 326-N, wherein the number of sensor coils is based on the particular implementation of powering surface 104.

To interface with sensor portion 304, portable device 106 has a RFID tag chip which contains a unique ID. RFID detector 330 comprises circuits to obtain the ID data transmitted by the RFID tag in the portable device. To detect a device, controller 306 applies RFID source signal 320 on every sensor coil 326 one by one by controlling multiplexer 322. When one sensor coil is activated, controller 306 can read the ID data in the RFID tag through RFID detector 330 if the current sensor coil is located under a device. After all of the sensor coils are scanned, it indicates there's no presence of any portable device on the surface if there's no any ID data is read. If yes, controller 306 calculates the locations of devices from the scan results. Then, the corresponding primary coils under devices are activated to transmit power. Aspects of such an implementation to interface between a power surface and a portable device using RFID tags are described in U.S. patent application Ser. No. 11/128,510, filed on May 13, 2005, titled “Inductive Powering Surface for Powering Portable Devices”. Besides a unique device ID, other information such as the power requirement amount of the device can be transferred to controller 306 via RFID technology. Thus the transferred energy can be adjusted to a suitable level. When device 106 is fully charged, it can send some commands to ask controller 306 to turn off the activated primary coils. Controller 306 can send some data like system state to device 106 via RFID as well.

Efficiency and power factor of the primary side 300 of inductive power surface 104 is not high. Power factor is a ratio of real power and apparent power, which is a number between 0 and 1, inclusively. Real power is the actual load power. Apparent power is a product of current and voltage of the circuit. Low-power factor loads increase losses and results in increased cost and thermal problems. High power factor can utilize AC source 308 efficiently so that more power can be transferred between primary coil(s) 314 (also shown as coils 202 in FIG. 2) and secondary coil(s) 204. When a portable device 106 is placed on various portions of inductive surface 104, the inductance of primary power coil(s) 314 may change due to the impacts of magnetic materials (e.g. ferrite) associated with the portable device. In such a scenario, it is difficult to calibrate a power factor using value-fixed capacitors. To address this, inductive power portion 302 utilizes a self-adaptive circuit to automatically correcting the power factor and maximize power transmission when power load changes. This self-adapting circuit is shown as impedance auto-match circuit/logic 310.

FIG. 4 shows an exemplary structure for an impedance auto-match circuit 310 to calibrate power factors of inductive loads between primary coils in an inductive power surface and secondary coils in a portable device, according to one embodiment. For purposes of exemplary description and illustration, FIG. 4 is described with respect to FIGS. 1 through 3, wherein the left-most digit of a component reference number indicates the particular figure where a component is/was first introduced. Referring now to FIG. 4, voltage between “Rsense” is in phase with the current. In this implementation, “Rsense” is a small-value resistor used to measure the current. The voltage between “Rsense” is in phase with its current. The voltage outputted by power source 308 may be so large that it can't be processed directly by a comparator. Amplifier 402 in voltage detector 404 adjusts the voltage value to a suitable level that can be operated by comparator 406. For example, since Rsense has a small value. The voltage between Rsense may be so small that it can't be processed correctly by a comparator. Amplifier 408 in current detector 410 adjusts the voltage value between Rsense to a suitable level that can be operated by comparator 412. There are two inputs for comparator 406: one is the output voltage from amplifier 402, the other is a reference voltage. When the output voltage from amplifier 402 is larger than the reference voltage, comparator 402 outputs a high level voltage, otherwise outputs a low level voltage. Thus a digital pulse signal related to the voltage is generated by comparator 406. So that the digital signal can be processed by a MCU or CPLD. Comparator 412 works like comparator 406, and outputs a digital pulse signal related to the current as well. Voltage detector 404 and current detector 410 should be fast enough so that the delays between their outputs and inputs are small and the voltage and current measurements are accurate. Digital signals from comparators 406 and 412 are input into voltage-current phase difference detector logic 414.

Voltage-current phase difference detector 414 detects the voltage-current phase difference from the two digital signals from comparators 406 and 412. The power factor is 1 and the efficiency is 100% when the voltage-current difference is zero, that is, the voltage and current are in phase. In order to get a maximum power factor and efficiency, the voltage-current phase difference should be a minimum. In one implementation, component 414 is a logical circuit outputting a rectangular signal 417 whose duty cycle is proportional to the phase difference. Lower duty cycle means lower phase difference and means higher power factor and higher efficiency. A rectangular wave is also known as a pulse wave, a repeating wave that only operates between two levels or values and remains at one of these values for a small amount of time relative to the other value. The rectangular signal is provided into switches controller logic 416.

Switches controller logic 416 is coupled to switches and compensation capacitors logic 418. Such coupling is shown by dotted lines from the switches controller 460 logic to respective switches and logic 418. The compensation capacitors (e.g., C1 through C16, etc.) provide a configurable capacitance series by being switched on or off via respective ones of the switches. For example, 0 nF (all capacitors are off), 1 nF (only capacitor C1 is on), 2 nF (only capacitor C2 is on), 3 nF (capacitors C1 and C2 are on) . . . 31 nF (all capacitors are on), etc. Capacitance values of respective ones in compensation capacitor logic 418 are scaled. In one implementation, for example, compensation capacitor switch values include, for example, 1 nF, 2 nF, 4 nF, 8 nF and 16 nF. “nF” stands for nanofarads, a type of capacitance unit. In another implementation, there are more or fewer switches and capacitors than the five (5) switches and capacitors shown in FIG. 4 (i.e., a configurable number of capacitors). In general, more capacitors can lead to more accurate result of the voltage-current phase difference. But in such a scenario, more switches and other controller resources would also be used.

Switches controller logic 416 evaluates rectangular signal(s) 417 received from voltage and current phase detector 414 to maintain a minimum phase difference between the current and voltage. In one implementation, switches controller logic 416 accomplishes this by switching on or off respective ones of the capacitors in logic 418. After a minimum phase difference is found, controller 416 continues to periodically measure phase difference. If phase difference changes (e.g., due to changes in load inductance, etc.) and is larger than a pre-defined threshold, controller 416 re-determines the minimum phase difference value. Otherwise, the compensation capacitors keep the original state. There are multiple techniques for switches controller 416 to determine such minimum phase differences.

In one implementation, for example, controller 416 determines minimum phase difference by scanning capacitance of all the compensation capacitors from the minimum capacitance value to the maximum capacitance value by switches, such as 0 nF, 1 nF, 2 nF, 3 nF, up to 31 nF. The duty cycle of the rectangular signal from phase difference detector 414 is measured by controller 416 and used to identify the minimum phase difference. For example, the state of lowest duty cycle is just the state of the minimum phase difference and maximum power factor and efficiency. After a scan of all the values, the minimum phase difference is identified and its relevant switches state (e.g., respective on/off states) is maintained. If phase difference changes (e.g., due to changes in load inductance, etc.) and is larger than a pre-defined threshold, controller 416 rescan and re-determines the minimum phase difference value. Load 422 is the primary activated coils and inductively coupled secondary circuits on the device side.

In another implementation, for example, switches controller 416 adjusts capacitance in increasing direction from the middle value like 16 nF. If the phase difference increases, switches controller 416 begins adjusting capacitance in the decreasing direction (i.e., decreases capacitance). Responsive to this capacitive adjustment, if the phase difference decreases, switches controller 416 continues to adjust capacitance in the original increasing capacitance direction. That is, controller 416 is trying to find a capacitance adjusting direction so that the phase difference is measured to be smaller. Controller 416 continues adjusting capacitance as the phase difference becomes smaller and smaller, until the phase difference begins to be bigger when one compensation capacitance is applied. At this point, controller 416 stops capacitance adjustments. Controller 416 identifies the minimum phase difference and maintains associated switches state (e.g., respective on/off states).

In view of the above inductive powering surface 104 provides a periodic dynamic voltage and current phase difference feedback loop solution to identify phase differences between current and voltage over time. These phase differences are used by switch controller 416 to selectively increase and/or decrease capacitance when applying power load 422 to respective power coils 314. This allows inductive powering surface 104 to transfer power to portable device efficiently. This optimized power is maximized, even if location of portable device 106 with respect to inductive powering surface 104 changes over time, because inductive powering surface 104 periodically calibrate the power factor and keep current and voltage in phase.

In one implementation, switches controller 416 is a CPLD (complex programmable logic device), MCU (microcontroller unit), etc. Various program data 420 associated with switches controller 416 operations (e.g., phase differences, switch states, capacitance values, threshold(s), and/or so on) are maintained in random access memory (RAM) associated with the switches controller 416.

### Exemplary Radio Leakage Shielding

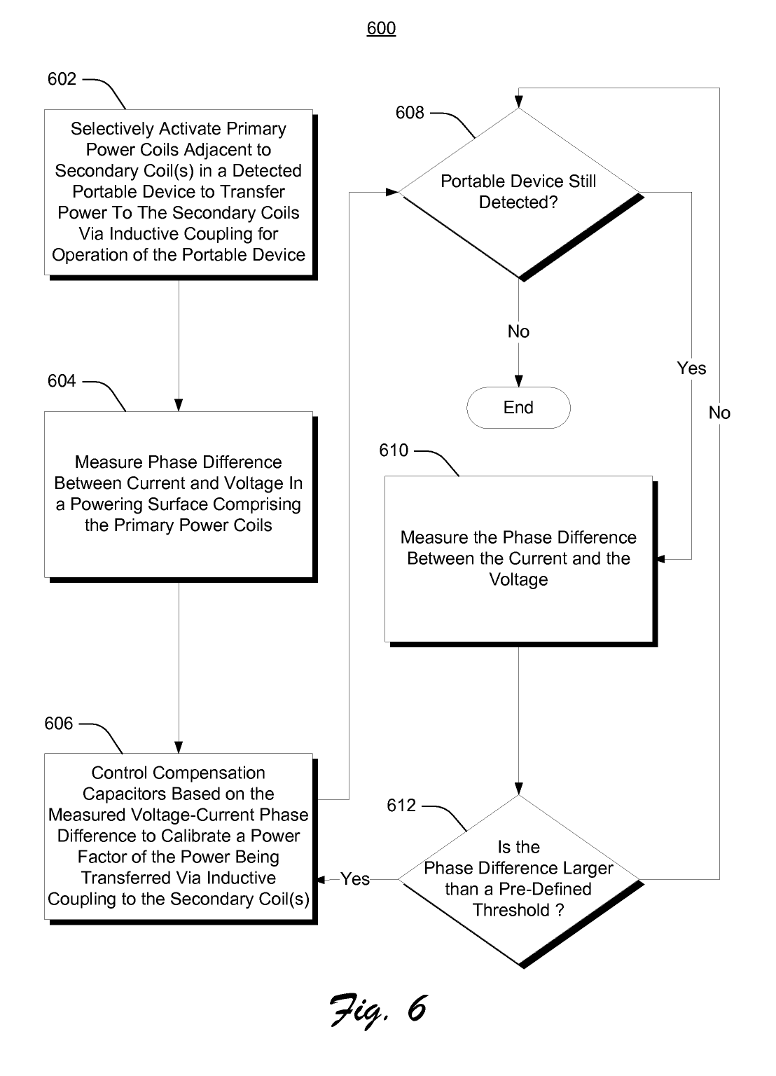

FIG. 5 shows an exemplary radio leakage shielding for inductive powering surface 104, according to one embodiment. High power, which may be up to 50W, is transferred by inductive powering surface 104 based on inductive coupling between primary coils 314 in the surface and the secondary coils 204 in the portable device 106. There should be no harm to the human body via such inductive powering. The design in FIG. 5 is to reduce the radio leakage as compared to conventional inductive powering surfaces. Ferrite is a magnetic material. Most of the magnetic circuit (a magnetic circuit is a closed path containing a magnetic flux) is completed between the secondary ferrite and the primary ferrite. But there may be some small field leakage in conventional systems. In this implementation, a thin metal sheet is mounted outside of the secondary ferrite and primary ferrite. When any leakage magnetic and electric field encounters the metal shield, some of the field energy is absorbed and some is reflected back into ferrite. This further shields radio leakage to users in proximity to inductive powering surface 104.

### Exemplary Procedures

FIG. 6 shows an exemplary procedure for an inductive powering surface for powering portable devices, according to one embodiment. Referring to FIG. 6, in operations of block 602, primary power coils in an inductive powering surface are selectively activated to transfer power to one or more secondary coils in a portable device. The operations of block 602 are responsive to detection, by the inductive powering surface, that the primary power coils are in proximity (e.g., adjacent, etc.) to the one or more secondary coils of the portable device. The power is transferred via inductive coupling between the primary and secondary coils.

Operations of block 604 measure phase difference between current and voltage in the inductive powering surface. Operations of block 606 control compensation capacitors in view of the measured voltage-current phase difference to calibrate a power factor of the inductive powering surface. The power factor being calibrated to maximize power being transferred from the primary coils via inductive coupling to the one or more secondary coils. Operations of block 608 determine whether the portable device (i.e., the one or more secondary coils in the portable device) are still detected in association with the inductive powering surface (i.e., the primary coils of the powering surface). If not, procedure 600 ends. Otherwise, operations of procedure 600 continue at block 610, where the phase difference between the current and the voltage is re-measured. Operations of block 612 determine whether the re-measured phase difference is larger than a predefined threshold indicating that the voltage and current are not in phase and the power factor associated with the inductive powering surface is low. If the re-measured phase difference is not greater than the predefined threshold, operations of procedure 600 continue at block 608, as described above. If the re-measured phase difference is larger than the predefined threshold, the procedure continues at block 606 where the compensation capacitors are adjusted/controlled based on the re-measured phase difference to re-calibrate the power factor, and thereby, maximize power being transferred via inductive coupling between the primary coils and the one or more secondary coils.

### Conclusion

Although the above sections describe an inductive powering surface for powering portable devices in language specific to structural features and/or methodological operations or actions, the implementations defined in the appended claims are not necessarily limited to the specific features or actions described. Rather, the specific features and operations for inductive powering surface for powering portable devices are disclosed as exemplary forms of implementing the claimed subject matter. For example, although FIG. 4 shows load and compensation capacitors being in series, in another implementation, such load and compensation capacitors are in parallel. In another example, in one implementation, logic associated with voltage detector 404, current detector 410, and voltage current phase difference detector 414 are on a single chip. In another example, in one implementation, Rsense of FIG. 4 is replaced with a transformer.

1. A powering device comprising:
an inductive powering surface, the inductive powering surface comprising an impedance auto-match circuit and other control circuits coupled to primary power coils, the impedance auto-match circuit and the other control circuits for selectively energizing the primary coils to transfer power via inductive coupling to secondary coil(s) in a portable device; and
wherein the impedance auto-match circuit is configured to detect voltage and current phase differences over time to calibrate a power factor to transfer an optimized power load to the secondary coil(s) to power the portable device.

2. The powering device of claim 1, wherein the power factor is based on a ratio of real power and apparent power, real power being actual load power, apparent power being a product of current and voltage associated with the circuit, the circuit comprising the primary power coils and inductively coupled secondary circuits associated with the portable device.

3. The powering device of claim 1, wherein the voltage and current phase differences are a result of changes in inductance of power coil(s) responsive to movement of the portable device over the inductive powering surface.

4. The powering device of claim 1, wherein the inductive powering surface comprises a radio leakage shield, the radio leakage shield comprises a thin metal sheet mounted outside of secondary ferrite and primary ferrite.

5. The powering device of claim 1, wherein responsive to determining that phase difference between current and voltage do not match, the impedance auto-match circuit is configured to calibrate the power factor via a non-fixed value capacitor matrix.

6. The powering device of claim 1, wherein the voltage and current phase differences are determined by a logical circuit that outputs a rectangular signal to a switches controller, the rectangular signal having a duty cycle proportional to a determined voltage and current phase difference, the switches controller turning on and off respective ones of multiple capacitors to minimize phase difference between current and voltage.

7. The powering device of claim 6, wherein the switches controller is a microcontroller or a complex programmable logic device.

8. The powering device of claim 6, wherein values associated with the multiple capacitors are scaled.

9. The powering device of claim 6, wherein a number of capacitors in the multiple capacitors are configurable.

10. The powering device of claim 6, wherein the multiple capacitors are in series with a load.

11. The powering device of claim 6, wherein the multiple capacitors are in parallel with a load.

12. The powering device of claim 6, wherein the logical circuit minimizes phase difference between current and voltage by:
(a) adjusting capacitance in increasing direction from a middle value;
(b) responsive to the adjusting:
if phase difference increases, moving capacitance in a decreasing direction to minimize the phase difference until the phase difference begins to decrease when one compensation capacitance is applied; and
if the phase difference decreases, continuing to adjust capacitance in the increasing direction to minimize the phase difference until the phase difference begins to decrease when one compensation capacitance is applied;
(c) maintaining associated switches state to provide power to the secondary coil(s); and
(d) if phase difference changes responsive to a change in load inductance, and if phase difference change is larger than a pre-defined threshold, rescanning and re-determining minimum phase difference by (a) and (b).

13. A method to provide inductive power to a portable device, the method comprising:
selectively energizing, by an impedance auto-match circuit in an inductive powering surface, primary coils in the inductive powering surface to provide power via inductive coupling to secondary coil(s) in a portable device; and
wherein the power is based on detected voltage and current phase differences caused at least in part by positioning of the portable device on different respective areas of the inductive powering surface.

14. The method of claim 13, wherein the power is based on a ratio of real power and apparent power, real power being capacity of a circuit for performing work over time, apparent power being a product of current and voltage associated with a circuit comprising the primary power coils.

15. The method of claim 13, wherein selectively energizing the primary coils further comprises:
determining that phase difference between current and voltage are minimized;
calibrating capacitors in a capacitor matrix to minimize voltage-current phase difference; and
wherein the calibrating results in an optimized power factor.

16. The method of claim 13, wherein the detected voltage and current phase differences are determined by a logical circuit that outputs a rectangular signal to a switches controller, the rectangular signal having a duty cycle proportional to a determined voltage and current phase difference, the switches controller turning on and off respective ones of multiple capacitors to minimize phase difference between current and voltage in the inductive powering surface.

17. The method of claim 16, wherein values associated with the multiple capacitors are scaled.

18. The method of claim 16, wherein a number of capacitors in the multiple capacitors are configurable.

19. The method of claim 16, wherein the logical circuit minimizes phase difference between current and voltage by:
(a) adjusting capacitance in increasing direction from a middle value;
(b) responsive to the adjusting:
if phase difference increases, moving capacitance in a decreasing direction to minimize the phase difference until the phase difference begins to decrease when one compensation capacitance is applied; and
if the phase difference decreases, continuing to adjust capacitance in the increasing direction to minimize the phase difference until the phase difference begins to decrease when one compensation capacitance is applied;
(c) maintaining associated switches state to provide power to the secondary coil(s); and
(d) if phase difference changes responsive to a change in load inductance, and if phase difference change is larger than a pre-defined threshold, rescanning and re-determining minimum phase difference by (a) and (b).

20. A method implemented by a powering device, the method comprising:
selectively activating primary coils adjacent to secondary coil(s) in a portable device to transfer power via inductive coupling to the secondary coil(s), the portable device being detected in association with a surface of the powering device;
measuring phase difference between current and voltage in the surface;
controlling compensation capacitors in the surface based on the phase difference to calibrate a power factor for the surface, the power factor being calibrated to maximize power transfer via inductive coupling between the primary coils and the secondary coil(s); and
while the primary coils are in adjacent association with the secondary coil(s):
(a) re-measuring the phase difference between the current and the voltage; and
(b) if the phase difference is larger than a pre-defined threshold, re-controlling compensation capacitors using the phase difference to re-calibrate the power factor to to maximize inductive power transfer between the primary coils and the secondary coil(s); and
wherein power transferred via inductive coupling to the secondary coil(s) allows for operation of the portable device.
